(19) United States
(12) Patent Application Publication
(10) Pub. No.: US 2024/0213470 A1
(43) Pub. Date: Jun. 27, 2024

(54) POSITIVE ELECTRODE FOR RECHARGEABLE LITHIUM BATTERY, AND RECHARGEABLE LITHIUM BATTERY INCLUDING THE SAME

(71) Applicant: SAMSUNG SDI CO., LTD., Yongin-si (KR)

(72) Inventors: Seonyoung KWON, Yongin-si (KR); Eunok OH, Yongin-si (KR); Jungwoo SON, Yongin-si (KR); Yuntaek OH, Yongin-si (KR); Minkyeong KANG, Yongin-si (KR); Taehee KWAK, Yongin-si (KR)

(21) Appl. No.: 18/473,966

(22) Filed: Sep. 25, 2023

(30) Foreign Application Priority Data
Dec. 16, 2022 (KR) 10-2022-0177251

(51) Int. Cl. H01M 4/525; H01M 4/36; H01M 4/505; H01M 10/0525

(52) U.S. Cl. CPC H01M 4/525; H01M 4/364; H01M 4/505; H01M 10/0525; H01M 2004/021

(57) ABSTRACT

A positive electrode for a rechargeable lithium battery includes a current collector and a positive electrode active material layer on the current collector, the positive electrode active material layer including a positive electrode active material, the positive electrode active material includes about 75 wt % to about 100 wt % of a first positive electrode active material in a form of single particles and including a lithium nickel-based composite oxide having a nickel content of greater than or equal to about 70 mol %, and about 0 wt % to about 25 wt % of a second positive electrode active material in a form of secondary particles in which a plurality of primary particles are aggregated and including a lithium nickel-based composite oxide, and, in an X-ray diffraction analysis of the positive electrode, a ratio of a peak intensity of a (003) plane to a (104) plane is greater than or equal to about 4.8.

### CROSS-REFERENCE TO RELATED APPLICATION

This application claims priority to and the benefit of Korean Patent Application No. 10-2022-0177251, filed in the Korean Intellectual Property Office on Dec. 16, 2022, the entire content of which is hereby incorporated by reference.

### BACKGROUND

### 1. Field

Embodiments of the present disclosure relate to a positive electrode for a rechargeable lithium battery and a rechargeable lithium battery including the same.

### 2. Description of the Related Art

Rechargeable lithium batteries are used in various fields, including mobile devices, energy storage systems, and electric vehicles, due to their high energy densities, high voltage capabilities, long life-cycles, and low self-discharge rates. Recently, as rechargeable lithium batteries are increasingly applied to electric vehicles, higher energy densities are desired or required. This has resulted in the utilization of high nickel-based lithium metal oxides having high nickel contents (e.g., amount) as positive electrode active materials.

However, a rechargeable lithium battery utilizing a lithium metal oxide with a layered structure and a high nickel content (e.g., amount) has a critical disadvantage of greatly deteriorated long-term life-cycle characteristics and thermal stability. Among such lithium metal oxides, a lithium nickel cobalt-based oxide is widely utilized, but because cobalt is expensive and has a limited reserve, efforts to minimize or reduce the cobalt content (e.g., amount) are increasing and/or desired. However, a positive electrode active material with low or no cobalt content (e.g., amount) has problems of decreased performance due to significantly reduced capacity, even when a driving voltage is increased, and lacks structural stability and thermal stability. Accordingly, research on substituting some metals with manganese and/or the like is being conducted.

A lithium nickel-based composite oxide may be in a form of a secondary particle in which a plurality of primary particles are aggregated, that is, in the form of polycrystals. The polycrystals become smaller, i.e., become composed of smaller primary particles, as the nickel content (e.g., amount) is increased, and thus result in deteriorated performance and reduced thermal stability. However, a lithium nickel-based composite oxide in the form of the single particle (i.e., a single large monolithic particle) has high structural stability and low cation mixing, and crack generation during the life-cycle is suppressed or reduced, thus realizing stable performance, even when the nickel content (e.g., amount) is increased.

### SUMMARY

Aspects of embodiments of the present disclosure are directed towards a positive electrode for a rechargeable lithium battery with an improved long-term life-cycle and thermal stability through the application of a long-term life-cycle and low-cost positive electrode active material which has reduced cation mixing due to high structural stability, exhibits an increase in crystal alignment, and which has suppressed or reduced crack generation during charge and discharge, improving problems of the comparable high nickel-based positive electrodes, such as low charge/discharge efficiency, thermal runaway, and/or the like.

Additional aspects will be set forth in part in the description which follows and, in part, will be apparent from the description, or may be learned by practice of the presented embodiments of the disclosure.

In one or more embodiments of the present disclosure, a positive electrode for a rechargeable lithium battery includes a current collector and a positive electrode active material layer on the current collector, the positive electrode active material layer including a positive electrode active material, wherein the positive electrode active material includes about 75 wt % to about 100 wt % of a first positive electrode active material in a form of a single particle (or single particles) and including a lithium nickel-based composite oxide having a nickel content (e.g., amount) of greater than or equal to about 70 mol % relative to a total metal content (e.g., amount) of the lithium nickel-based composite oxide excluding lithium and oxygen, and about 0 wt % to about 25 wt % of a second positive electrode active material in a form of a secondary particle in which a plurality of primary particles are aggregated and including a lithium nickel-based composite oxide, and in an X-ray diffraction analysis of the positive electrode, a ratio of a peak intensity of the (003) plane to a peak intensity of the (104) plane is greater than or equal to about 4.8.

One or more embodiments of the present disclosure provide a rechargeable lithium battery including a positive electrode including the positive electrode active material, a negative electrode, and an electrolyte.

The positive electrode for a rechargeable lithium battery according to one or more embodiments may not only realize structural stability and a long-term life-cycle, but may also overcome the reduced performance problems of high nickel-based positive electrodes and improve charge/discharge efficiency, life-cycle characteristics, and thermal stability through the application of an economical positive electrode active material.

### BRIEF DESCRIPTION OF THE DRAWINGS

FIG. 1 is a schematic view illustrating a rechargeable lithium battery according to one or more embodiments of the present disclosure.

FIG. 2 is a scanning electron microscope image of the first positive electrode active material prepared in Preparation Example 1.

FIG. 3 is a life-cycle characteristic evaluation graph of coin cells of Examples 1 and 2 and Comparative Examples 1, 2, and 3.

### DETAILED DESCRIPTION

The present disclosure may be modified in many alternate forms, and thus specific embodiments will be illustrated in the drawings and described in more detail. It should be understood, however, that it is not intended to limit the present disclosure to the particular forms disclosed, but rather, is intended to cover all modifications, equivalents, and alternatives falling within the spirit and scope of the present disclosure.

Embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise.

As used herein, “combination thereof” means a mixture, laminate, composite, copolymer, alloy, blend, reaction product, and/or the like of the constituents.

Herein, it should be understood that the terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout, and duplicative descriptions thereof may not be provided the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the term “and/or” includes any and all combinations of one or more of the associated listed items. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

In addition, “layer” herein includes not only a shape formed on the whole surface when viewed from a plan view, but also a shape formed on part of a surface.

In the present disclosure, when particles are spherical, “diameter” indicates a particle diameter or an average particle diameter, and when the particles are non-spherical, the “diameter” indicates a major axis length or an average major axis length. In addition, the average particle diameter can be measured by a method generally available to those skilled in the art, for example, may be measured by a particle size analyzer, or may be measured by a transmission electron microscope image or a scanning electron microscope image. Alternatively, it is possible to obtain an average particle diameter value by measuring utilizing a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. In addition, unless otherwise defined, the average particle diameter may be obtained by measuring the size (diameter or length of the major axis) of about 20 particles randomly in a scanning electron microscope image to obtain a particle size distribution, and in the particle size distribution, taking the diameter (D50) of the particles having a cumulative volume of 50 volume % as the average particle diameter.

Herein, “or” is not to be construed as an exclusive meaning, for example, “A or B” is construed to include A, B, A+B, and/or the like.

In addition, “metal” is interpreted as a concept including general metals, transition metals, and metalloids (semimetals).

### Positive Electrode

In one or more embodiments, a positive electrode for a rechargeable lithium battery includes a current collector, and a positive electrode active material layer on the current collector, wherein the positive electrode active material layer includes a positive electrode active material, and the positive electrode active material includes about 75 wt % to about 100 wt % of a first positive electrode active material in a form of a single particle (e.g., a monolithic particle or a plurality of single particles), the first positive active material including a lithium nickel-based composite oxide having a nickel content (e.g., amount) of greater than or equal to about 70 mol % relative to the total metal content (e.g., amount) of the lithium nickel-based composite oxide excluding lithium and oxygen, and about 0 wt % to about 25 wt % of a second positive electrode active material in a form of a secondary particle in which a plurality of primary particles are aggregated (e.g., a plurality of secondary particles each including a plurality of aggregated primary particles), the second positive electrode active material including a lithium nickel-based composite oxide, and in an X-ray diffraction analysis of the positive electrode a ratio (I₀₀₃/I₁₀₄) of a peak intensity of the (003) plane to a peak intensity of the (104) plane is greater than or equal to about 4.8.

The X-ray diffraction analysis (XRD) may be performed not on an individual positive electrode active material but on a compressed positive electrode plate, wherein the positive electrode plate has completed an initial charge and discharge. The peak intensity means intensity indicated by a maximum value (maximum height) of an X-ray diffraction peak shown in an XRD graph. The (104) plane means a lattice plane corresponding to a Miller index 104, and the (003) plane means a lattice plane corresponding to a Miller index 003.

In the process of forming and compressing the positive electrode active material layer on the current collector, the (003) plane of the positive electrode active material has an orientation, and according to one or more embodiments, a positive electrode plate having a peak intensity ratio of the (003) plane to the (104) plane in a range of greater than or equal to about 4.8 may be obtained. This positive electrode may improve initial charge/discharge efficiency, life-cycle characteristics, and thermal stability due to high crystallinity and high structural stability of the positive electrode active material in the compressed electrode plate. In one or more embodiments, the I₀₀₃/I₁₀₄ ratio may be, for example, about 4.8 to about 15, about 4.8 to about 10, or about 4.8 to about 8.

In one or more embodiments, in the X-ray diffraction analysis of the positive electrode, a peak full width at half maximum (FWHM) of the (003) plane may be less than or equal to about 0.12. Herein, in the positive electrode plate, the positive electrode active material has high crystallinity and high structural stability, realizing long-term life-cycle characteristics and stability.

The positive electrode may have a density of greater than or equal to about 3.4 g/cc. The density of the positive electrode may be expressed as a density of a positive electrode mixture and may refer to a density of the positive electrode after the compressing. For example, the density of the positive electrode may be measured after coating a positive electrode active material composition on a positive electrode current collector followed by drying and compressing, and obtained by dividing a weight of all the other components except for the current collector in the positive electrode by a volume. The density of the positive electrode according to one or more embodiments may be, for example, about 3.4 g/cc to about 4.0 g/cc, about 3.4 g/cc to about 3.9 g/cc, or about 3.4 g/cc to about 3.8 g/cc. When the above density ranges are satisfied, the positive electrode may realize high capacity and high energy density.

In one or more embodiments, the positive electrode active material may include about 90 wt % to about 100 wt % of the first positive electrode active material and about 0 wt % to about 10 wt % of the second positive electrode active material. In this case, the ratio of the peak intensity of the (003) plane to the peak intensity of the (104) plane in the X-ray diffraction analysis of the positive electrode may be greater than or equal to about 6.5, for example, about 6.5 to about 15, about 6.5 to about 10, or about 7.0 to about 9.0. When the ratio of these peak intensities is satisfied, the positive electrode may exhibit very high crystallinity and structural stability, and may demonstrate high initial charge/discharge efficiency and long-term life-cycle characteristics.

In one or more embodiments, the positive electrode active material may include about 75 wt % to about 95 wt % of the first positive electrode active material about 5 wt % to about 25 wt % of the second positive electrode active material. In this case, the ratio of the peak intensity of the (003) plane to the peak intensity of the (104) plane in the X-ray diffraction analysis of the positive electrode may be about 4.8 to about 6.5, to realize high capacity, initial charge/discharge efficiency, and long-term life-cycle characteristics.

### First Positive Electrode Active Material

The first positive electrode active material is in the form of a single particle (e.g., a plurality of single particles), exists alone without a grain boundary within the particle, is composed of one particle, and has a monolith structure, a one body structure, or a non-aggregated particle, in which particles are not aggregated with each other but exist as an independent phase in terms of morphology, and may be expressed as a single particle (one body particle, single grain), for example, as a single crystal. The first positive electrode active material in the form of the single particle (e.g., single particles) may exhibit improved life-cycle characteristics while realizing high capacity and high energy density.

The lithium nickel-based composite oxide of the first positive electrode active material may be represented by Chemical Formula 1. Chemical Formula 1 may be referred to as a high-nickel-based positive electrode active material.

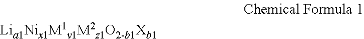

In Chemical Formula 1, 0.9≤a1≤1.8, 0.7≤x1≤1, 0≤y1≤0.3, 0≤z1≤0.3, 0.9≤x1+y1+z1≤1.1, 0≤b1≤0.1, M¹ and M² may each independently be at least one element of (e.g., one element selected from) Al, B, Ba, Ca, Ce, Co, Cr, Cu, Fe, Mg, Mn, Mo, Nb, Si, Sr, Ti, V, W, and/or Zr; and X is at least one element of (e.g., one element selected from) F, P, and/or S.

For example, the lithium nickel-based composite oxide of the first positive electrode active material may be a cobalt-free lithium nickel-based composite oxide, and specific examples thereof may be a layered cobalt-free lithium nickel-based composite oxide, a cobalt-free high nickel-based composite oxide, or cobalt-free lithium nickel-manganese-based composite oxide. Herein, cobalt-free may mean no cobalt, no inclusion or utilization of cobalt, or only trace amounts of cobalt.

Recently, while a demand for large or high-capacity rechargeable lithium batteries is rapidly increasing, because a supply of a positive electrode active material containing cobalt, a rare metal, is extremely insufficient, development of a cobalt-free positive electrode active material utilizing no cobalt is being actively made. However, because cobalt plays a key role in forming a structure of the positive electrode active material, when the cobalt is removed, there may be problems of increasing resistance and not securing a long life due to structural defects, and deteriorating performance such as a decrease in capacity and efficiency and/or the like. Generally available cobalt-free positive electrode active materials have an olivine-based crystal structure such as lithium iron phosphate (LFP), lithium manganese phosphate (LMP), lithium manganese iron phosphate (LMFP), and/or the like or a spinel crystal structure such as lithium manganese oxide (LMO) and/or the like, rather than a layered structure. These materials have high structural stability but a limitation of low capacity due to a small amount of usable lithium inside the structure. In contrast, a cobalt-free lithium nickel-based oxide with the layered structure has a relatively high usable lithium content (e.g., amount) in the structure and thus exhibits excellent or suitable capacity and efficiency characteristics and accordingly, is suitable for high-capacity batteries. However, this cobalt-free lithium nickel-based oxide is structurally unstable and thus may lead to structural degradation after repeated charges and discharges, resultantly deteriorating long-term life-cycle characteristics.

One or more embodiments of the present disclosure introduces a cobalt-free high nickel-based first positive electrode active material in the form of the single particle (e.g., a plurality of single particles) and set crystallinity on a positive electrode plate, for example, having a ratio of peak intensity of the (003) plane to that of the (104) plane in an X-ray diffraction analysis at a set or predetermined level or higher in order to improve structural stability of the positive electrode active material in a positive electrode and suppress or reduce crack generation during the charges and discharges, succeeding in concurrently (e.g., simultaneously) securing capacity characteristics, initial charge and discharge characteristics, long-term life-cycle characteristics, and thermal stability of a rechargeable lithium battery.

As a positive electrode active material including a cobalt-free lithium nickel-based composite oxide, a positive electrode active material in a form of a secondary particle in which a plurality of primary particles are aggregated may be often cracked during the charges and discharges due to deteriorated structural stability, failing in realizing long-term life-cycle characteristics. In contrast, one or more embodiments introduces the first positive electrode active material containing cobalt-free lithium nickel-based composite oxide and having the form of the single particle (e.g., a plurality of single particles), wherein this positive electrode active material in the form of the single particle (e.g., a plurality of single particles) has excellent or suitable structural stability due to a short lithium migration path and excellent or suitable alignment of crystals, improving long-term life-cycle characteristics of a rechargeable lithium battery and resultantly, providing a rechargeable lithium battery having high capacity, long-term life-cycle characteristics, and excellent or suitable thermal stability as well as a low cost.

For example, the cobalt-free lithium nickel-based composite oxide may be represented by Chemical Formula 2. Chemical Formula 2 may be referred to as a layered cobalt-free high-nickel positive electrode active material, or may be referred to as a cobalt-free nickel-manganese positive electrode active material.

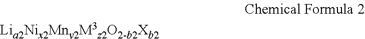

In Chemical Formula 2, 0.9≤a2≤1.8, 0.7≤x2<1, 0<y2≤0.3, 0≤z2≤0.3, 0.9≤x2+y2+z2≤1.1, 0≤b2≤0.1, M³ is at least one element of (e.g., one element selected from) Al, B, Ba, Ca, Ce, Cr, Cu, Fe, Mg, Mo, Nb, Si, Sr, Ti, V, W, and/or Zr, and X is at least one element of (e.g., one element selected from) S, F, and/or P.

The average particle diameter (D50) of single particles of the first positive electrode active material may be about 1 μm to about 12 μm, for example, about 1 μm to about 10 μm, about 1 μm to about 8 μm, or about 3 μm to about 6 μm. When the above particle size ranges are satisfied, high energy density may be implemented while exhibiting high capacity. Herein, the average particle diameter of the first positive electrode active material may be obtained by measuring the size (diameter or length of the major axis) of about 20 particles randomly among single particles in a scanning electron microscope image for the positive electrode to obtain a particle size distribution, and in the particle size distribution, taking the diameter (D50) of the particles having a cumulative volume of 50 volume % as the average particle diameter.

The first positive electrode active material may be prepared by a general co-precipitation method. For example, a nickel precursor and optionally a precursor of another metal element are co-precipitated to obtain a nickel-based hydroxide, a mixture of this and a lithium raw material is heat-treated to produce a lithium nickel-based composite oxide, and after the heat treatment, a crushing operation may be added to obtain a powder in a form of a single particle (e.g., in a single particle form or single particles). The pulverizing may take about 10 minutes to about 4 hours.

### Second Positive Electrode Active Material

The second positive electrode active material is in a form of a secondary particle (e.g., in a secondary particle form or a plurality of secondary particles) in which at least two or more primary particles are aggregated while containing lithium nickel-based composite oxide, and may be in the form of, for example, a polycrystal (e.g., polycrystals). According to one or more embodiments, when the second positive electrode active material is included, a positive electrode for a rechargeable lithium battery may realize higher energy density.

The average particle diameter (D50) of the secondary particles of the second positive electrode active material may be about 5 μm to about 20 μm, for example, about 8 μm to about 18 μm, or about 10 μm to about 15 μm. When the above particle size ranges are satisfied, high energy density can be implemented while exhibiting high capacity. Herein, the average particle diameter of the second positive electrode active material may be obtained by measuring the size (diameter or length of the major axis) of about 20 particles randomly among the particles in the form of the secondary particles in a scanning electron microscope image for the positive electrode to obtain a particle size distribution, and in the particle size distribution, taking the diameter (D50) of the particles having a cumulative volume of about 50 volume % as the average particle diameter.

The composition of the lithium nickel-based composite oxide of the second positive electrode active material may be the same as or different from that of the first positive electrode active material.

1 For example, the lithium nickel-based composite oxide of the second positive electrode active material may be represented by Chemical Formula 1. The second positive electrode active material may be a layered high-nickel-based positive electrode active material represented by Chemical Formula 1.

For example, the second positive electrode active material may include a cobalt-free lithium nickel-based composite oxide. Details of the cobalt-free or cobalt-free positive electrode active material are as described above. For example, the cobalt-free lithium nickel-based composite oxide of the second positive electrode active material may be represented by Chemical Formula 2.

When both the first positive electrode active material and the second positive electrode active material are cobalt-free positive electrode active materials, high capacity and long-term life-cycle characteristics may be implemented while cost is reduced, and energy density may be further improved by mixing two types (kinds) of positive electrode active materials, single particles and secondary particles.

The second positive electrode active material may be prepared by a general co-precipitation method. For example, a lithium nickel-based composite oxide may be produced by co-precipitating a nickel precursor and optionally a precursor of another metal element to obtain a nickel-based hydroxide, mixing this with a lithium raw material and heat-treating the result.

The positive electrode active material layer may further include a binder and/or a conductive material in addition to the positive electrode active material.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

A content (e.g., amount) of the binder in the positive electrode active material layer may be about 1 wt % to about 5 wt % based on the total weight of the positive electrode active material layer.

The conductive material is included to provide electrode conductivity and any electrically conductive material may be utilized as a conductive material unless it causes a chemical change. Examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber including copper, nickel, aluminum, silver, and/or the like; a conductive polymer such as a polyphenylene derivative; or a mixture thereof.

A content (e.g., amount) of the conductive material in the positive electrode active material layer may be about 1 wt % to about 5 wt % based on the total weight of the positive electrode active material layer.

An aluminum foil may be utilized as the positive electrode current collector, but the present disclosure is not limited thereto.

### Rechargeable Lithium Battery

One or more embodiments of the present disclosure provide a rechargeable lithium battery including the positive electrode, the negative electrode, and the electrolyte.

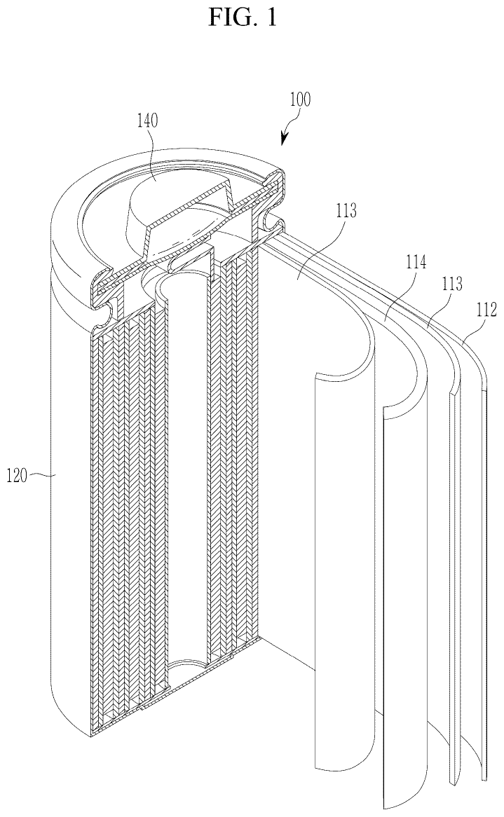

FIG. 1 is a schematic view illustrating a rechargeable lithium battery according to one or more embodiments of the present disclosure. Referring to FIG. 1, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, negative electrode 112, and separator 113, a battery case 120 housing the battery cell, and a sealing member 140 sealing the battery case 120.

### Negative Electrode

A negative electrode for a rechargeable lithium battery includes a current collector and a negative electrode active material layer on the current collector. The negative electrode active material layer may include a negative electrode active material, and may further include a binder and/or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal of (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and/or a combination thereof, but not Si) and the Sn-based negative electrode active material may include Sn, SnO₂, an Sn—R alloy (wherein R is an alkali metal, an alkaline-earth metal, a Group 13 element, a Group 14 element, a Group 15 element, a Group 16 element, a transition metal, a rare earth element, and/or a combination thereof, but not Sn). At least one of these materials may be mixed with SiO₂. The elements Q and R may include (e.g., may be selected from) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof.

For example, the negative electrode active material may include silicon-carbon composite particles. An average particle diameter (D50) of the silicon-carbon composite particles may be, for example, about 0.5 μm to about 20 μm. The average particle diameter (D50) is measured by a particle size analyzer and refers to a diameter of particles at about 50 volume % of a cumulative volume in a particle size distribution. Based on about 100 wt % of the silicon-carbon composite particles, silicon may be included in an amount of about 10 wt % to about 60 wt %, and carbon may be included in an amount of about 40 wt % to about 90 wt %. The silicon-carbon composite particles may include, for example, a core containing silicon particles and a carbon coating layer disposed on the surface of the core. The silicon particles in the core may have an average particle diameter (D50) of about 10 nm to about 1 μm or about 10 nm to about 200 nm. The silicon particles may exist as silicon alone, in a form of a silicon alloy, or in an oxidized form. The oxidized silicon may be expressed as SiOₓ (0<x<2). In one or more embodiments, the carbon coating layer may have a thickness of about 5 nm to about 100 nm.

For example, the silicon-carbon composite particle may include a core including silicon particles and crystalline carbon and a carbon coating layer disposed on the surface of the core and including amorphous carbon. For example, in the silicon-carbon composite particle, amorphous carbon may not exist in the core but only in the carbon coating layer. The crystalline carbon may be artificial graphite, natural graphite, or a combination thereof, and the amorphous carbon may be coal-based pitch, mesophase pitch, petroleum-based pitch, coal-based oil, petroleum-based heavy oil, or a polymer resin (phenol resin, furan resin, polyimide resin, etc.). In such cases, a content (e.g., amount) of the crystalline carbon may be about 10 wt % to about 70 wt % and a content (e.g., amount) of the amorphous carbon may be about 20 wt % to about 40 wt % based on 100 wt % of the silicon-carbon composite particle.

In the silicon-carbon composite particle, the core may include a pore in the central portion. A radius of the pore may be about 30 length % to about 50 length % of a radius of the silicon-carbon composite particle.

The aforementioned silicon-carbon composite particle may effectively suppress or reduce problems such as volume expansion, structural collapse, particle crushing, and/or the like resulting from the charges and discharges, thus preventing or substantially preventing disconnection of a conductive path and realizing high capacity and high efficiency and accordingly, may be advantageously utilized in high voltage or high-speed charging conditions.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and utilized, the mixing ratio may be a weight ratio of about 1:99 to about 90:10.

In the negative electrode active material layer, the negative electrode active material may be included in an amount of about 95 wt % to about 99 wt % based on the total weight of the negative electrode active material layer.

In one or more embodiments, the negative electrode active material layer further includes a binder, and may optionally further include a conductive material. A content (e.g., amount) of the binder in the negative electrode active material layer may be about 1 wt % to about 5 wt % based on the total weight of the negative electrode active material layer. In one or more embodiments, when the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, and/or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected from) polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. The alkali metal may be Na, K, or Li. The amount of the thickener utilized may be about 0.1 parts by weight to about 3 parts by weight based on 100 parts by weight of the negative electrode active material.

The conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber including copper, nickel, aluminum, silver, and/or the like; a conductive polymer such as a polyphenylene derivative; and/or a mixture thereof.

The negative electrode current collector may include one of (e.g., one selected from) a copper foil, a nickel foil, a stainless steel foil, a titanium foil, a nickel foam, a copper foam, a polymer substrate coated with a conductive metal, and/or a combination thereof.

### Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In one or more embodiments, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based solvent may be an aromatic hydrocarbon-based compound represented by Chemical Formula I.

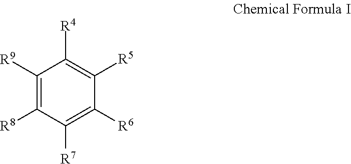

In Chemical Formula I, R⁴ to R⁹ may each independently be the same or different and may include (e.g., may be selected from) hydrogen, a halogen, a C1 to C10 alkyl group, a C1 to C10 haloalkyl group, and/or a combination thereof.

Specific examples of the aromatic hydrocarbon-based solvent may include (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylene carbonate or an ethylene carbonate-based compound represented by Chemical Formula II in order to improve the life-cycle of a battery.

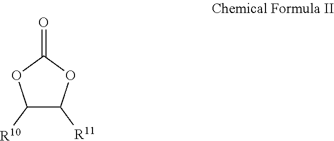

In Chemical Formula II, R¹⁰ and R¹¹ may each independently be the same or different and may include (e.g., may be selected from) hydrogen, a halogen, a cyano group, a nitro group, and/or fluorinated C1 to C5 alkyl group, provided that at least one of R¹⁰ and/or R¹¹ is a halogen, a cyano group, a nitro group, and/or fluorinated C1 to C5 alkyl group, and R¹⁰ and R¹¹ are not concurrently (e.g., simultaneously) hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving life-cycle may be utilized within an appropriate or suitable range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt include at least one of (e.g., one selected from) LiPF₆, LiBF₄, LiSbF₆, LiAsF₆, LiN(SO₂C2F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiCIO₄, LiAlO₂, LiAICI₄, LIPO₂F₂, LiN(CₓF₂ₓ₊₁SO₂)(C_{y}F_{2y+1}SO₂), wherein x and y are natural numbers, for example, an integer in a range of 1 to 20, lithium difluoro(bisoxalato) phosphate, LiCl, LiI, LiB(C₂O₄)₂ (lithium bis(oxalato) borate, LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The separator 113 separates a positive electrode 114 and a negative electrode 112 and provides a transporting passage for lithium ions and may be any generally-available separator utilized in a lithium ion battery. In other words, it may have low resistance to ion transport and excellent or suitable impregnation for an electrolyte. For example, the separator 113 may include a glass fiber, polyester, polyethylene, polypropylene, polytetrafluoroethylene, or a combination thereof, and may be in the form of a non-woven fabric or a woven fabric. For example, in a lithium ion battery, a polyolefin-based polymer separator such as polyethylene and/or polypropylene is mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for rechargeable lithium batteries are generally available in the art.

The rechargeable lithium battery according to one or more embodiments may be utilized in an electric vehicle (EV), a hybrid electric vehicle such as a plug-in hybrid electric vehicle (PHEV), and a portable electronic device because it implements a high capacity and has excellent or suitable storage stability, life-cycle characteristics, and high rate characteristics at high temperatures.

Hereinafter, examples of the present disclosure and comparative examples are described. However, the examples are for the purpose of illustration and are not to be construed as limiting the present disclosure.

### Preparation Example 1: Preparation of First Positive Electrode Active Material in Form of Single Particle

Nickel sulfate and manganese sulfate in a mole ratio of 75:25 were dissolved in distilled water as a solvent to prepare a mixed solution of metal raw materials, and a diluted solution of ammonia water (NH₄OH) and sodium hydroxide (NaOH) as a precipitant were prepared to form a complex compound. In a reactor, the mixed solution of the metal raw materials, the ammonia water, and the sodium hydroxide were added and then reacted for about 20 hours, while being stirred. Subsequently, a slurry solution in the reactor was filtered and dried with distilled water with high purity for 24 hours, obtaining a positive electrode active material precursor (Ni_{0.75}Mn_{0.25}OH)₂ powder.

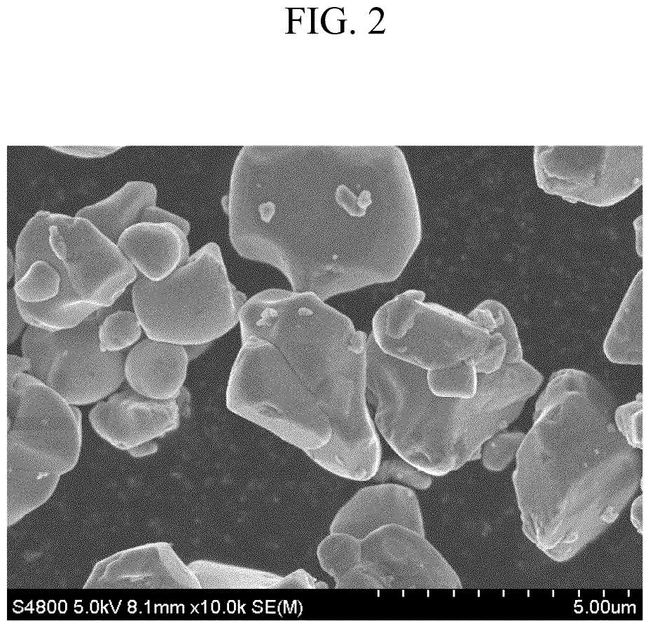

Then, the obtained positive electrode active material precursor was mixed with lithium hydroxide to have a Li/(Ni+Mn) ratio of 1.03 and then, heat-treated under an oxygen atmosphere at about 900° C. for 10 hours. The obtained product was pulverized for about 30 minutes, obtaining a first positive electrode active material (Li_{1.03}Ni_{0.75}Mn_{0.25}O₂) in a form of a single particle (e.g. single particles). FIG. 2 is a scanning electron microscope (SEM) image of the first positive electrode active material in the form of single particles according to Preparation Example 1. The single particles have an average particle diameter (D50) of about 2.7 μm, when measured through the SEM image.

### Preparation Example 2: Preparation of Second Positive Electrode Active Material in Form of Secondary Particle

Nickel sulfate and manganese sulfate in a mole ratio of 75:25 were mixed in distilled water as a solvent to prepare a mixed solution of metal raw materials, and in order to form a complex compound, a diluted solution of ammonia water (NH₄OH) and sodium hydroxide (NaOH) as a precipitant were prepared. After adding the ammonia water dilution to a continuous reactor, the mixed solution of metal raw materials was substantially continuously added thereto, and the sodium hydroxide was added thereto. A reaction slowly proceeded for about 80 hours, and when the reaction was stabilized, a product overflown therefrom was collected and then washed and dried, obtaining a positive electrode active material precursor (Ni_{0.75}Mn_{0.25}(OH)₂) powder.

The obtained positive electrode active material precursor and the lithium hydroxide were mixed to have a Li/(Ni+Mn) ratio of 1.03 and then, put in a firing furnace to perform a heat treatment under an oxygen atmosphere at about 840° C. for 15 hours, obtaining a second positive electrode active material (Li_{1.03}Ni_{0.75}Mn_{0.25}O₂) in the form of a secondary particle in which a plurality of primary particles are aggregated (e.g., secondary particles each including a plurality of aggregated primary particles). The secondary particles had an average particle diameter (D50) of about 14 μm, when measured through an SEM image.

### Example 1

### (1) Manufacture of Positive Electrode

Positive electrode slurry was prepared by mixing 95 wt % of the first positive electrode active material in the form of single particles according to Preparation Example 1, 3 wt % of a polyvinylidene fluoride binder, and 2 wt % of carbon nanotube conductive material in an N-methyl pyrrolidone solvent. The positive electrode slurry was coated at a loading level of 10 mg/cm² on an aluminum current collector, dried at 120° C. for 1 hour or more, and compressed at a density of 3.49 g/cc, manufacturing a 42 μm-thick positive electrode for a rechargeable lithium battery.

### (2) Manufacture of Rechargeable Lithium Battery Cell

The positive electrode was assembled with a lithium metal negative electrode and an about 20 μm-thick porous polyethylene separator therebetween to manufacture an electrode assembly, which was housed in a case, and an electrolyte is injected into the case, manufacturing a coin cell. Herein, the electrolyte was prepared by dissolving 1.15 M LiPF₆ in a mixed solvent of ethylenecarbonate (EC), ethylmethylcarbonate (EMC), and dimethylcarbonate (DMC) in a volume ratio of 3:3:4.

### Example 2

A positive electrode and a coin cell were manufactured in substantially the same manner as in Example 1 except that 75 wt % of the first positive electrode active material in the form of the single particle according to Preparation Example 1 and 25 wt % of the second positive electrode active material in a form of a secondary particle according to Preparation Example 2 were utilized.

### Comparative Example 1

A positive electrode and a coin cell were manufactured in substantially the same manner as in Example 1 except that 50 wt % of the first positive electrode active material in the form of single particles according to Preparation Example 1 and 50 wt % of the second positive electrode active material in the form of secondary particles according to Preparation Example 2 were utilized.

### Comparative Example 2

A positive electrode and a coin cell were manufactured in substantially the same manner as in Example 1 except that 25 wt % of the first positive electrode active material in the form of single particles according to Preparation Example 1 and 75 wt % of the second positive electrode active material in the form of secondary particles according to Preparation Example 2 were utilized.

### Comparative Example 3

A positive electrode and a coin cell were manufactured in substantially the same manner as in Example 1 except that 100 wt % of the second positive electrode active material in the form of secondary particles according to Preparation Example 2 was utilized.

### Evaluation Example 1: X-Ray Diffraction Analysis

The coin cells of Examples 1 and 2 and Comparative Examples 1 to 3 were initially charged under constant current (0.2 C) and constant voltage (4.25 V, 0.05 C cut-off) conditions, paused for 10 minutes, and discharged to 3.0 V under constant current (0.2 C) conditions to perform an initial charge and discharge.

An X-ray diffraction analysis (XRD) was performed on the positive electrodes of Examples 1 and 2 and Comparative Examples 1 to 3, which had completed the initial charge and discharge, to obtain a ratio of a peak intensity of the (003) plane to that of the (104) plane (I(003)/I(104)), and the results are shown in Table 1, and to obtain a full width at half maximum (FWHM) of the (003) plane (FWHM₀₀₃), the results of which are also shown in Table 1. X′pert made by Phillips was used as an analytical instrument, and CuK-alpha (wavelength: 1.5405980 Å) was used as an excitation source.

TABLE 1

| | I₀₀₃/I₁₀₄ | FWHM₀₀₃ |
|---|---|---|
| Comparative Example 3 | 1.356 | 0.161 |
| Comparative Example 2 | 2.342 | 0.125 |
| Comparative Example 1 | 3.588 | 0.122 |
| Example 2 | 4.806 | 0.119 |
| Example 1 | 7.115 | 0.108 |

Referring to Table 1, Examples 1 and 2 satisfy a I₀₀₃/I₁₀₄ ratio of greater than or equal to about 4.8, but Comparative Examples 1 to 3 do not satisfy it, and Examples 1 and 2 satisfy FWHM₀₀₃ of less than or equal to 0.12 but Comparative Examples 1 to 3 do not satisfy it.

### Evaluation Example 2: Evaluation of Initial Charge/Discharge Efficiency and Life-Cycle Characteristics

Table 2 shows initial charge, initial discharge, and initial charge/discharge efficiency, which is a ratio of the initial discharge to the initial charge.

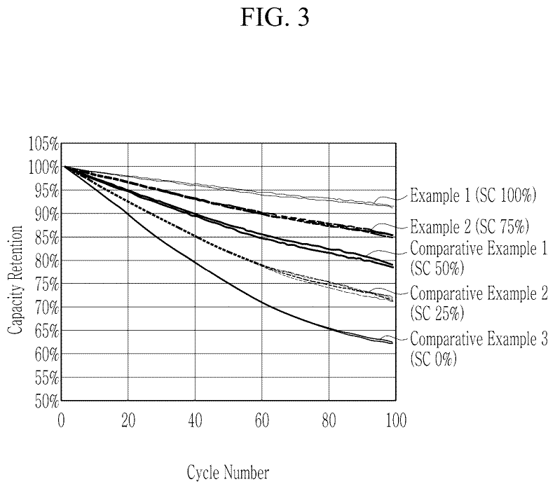

After the initial charge and discharge, the cells are repeatedly charged and discharged 100 times or more at 25° C. at 1 C/1 C. Then, the cells are evaluated with respect to capacity retention, which is a ratio of discharge capacity at each cycle to the initial discharge capacity, that is, high-temperature life-cycle characteristics, and the results are shown in FIG. 3.

TABLE 2

| | Initial charge | Initial discharge | Initial |
|---|---|---|---|
| | capacity | capacity | efficiency |
| | (mAh/g) | (mAh/g) | (%) |
| Comparative Example 3 | 235.4 | 201.4 | 85.6 |
| Comparative Example 2 | 234.7 | 200.7 | 85.5 |
| Comparative Example 1 | 234.6 | 200.6 | 85.5 |
| Example 2 | 235.3 | 201.8 | 85.8 |
| Example 1 | 235.7 | 203.1 | 86.2 |

Referring to Table 2, Examples 1 and 2 exhibit somewhat improved initial discharge capacity and initial efficiency, compared with Comparative Examples 1 to 3. Referring to FIG. 3, Examples 1 and 2 exhibit improved capacity retention at the 100^{th} cycle, compared with Comparative Examples 1 to 3. For example, Example 1 satisfies capacity retention of greater than or equal to 90% at the 100^{th} cycle.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While certain embodiments of the present disclosure have been illustrated and described, it is understood by those of ordinary skill in the art that certain modifications and changes can be made to the described embodiments without departing from the spirit and scope of the present disclosure as defined by the following claims, and equivalents thereof.

Reference Numerals

| | |
|---|---|
| 100: rechargeable lithium battery | 112: negative electrode |
| 113: separator | 114: positive electrode |
| 120: battery case | 140: sealing member |

What is claimed is:

1. A positive electrode for a rechargeable lithium battery, the positive electrode comprising:
a current collector and a positive electrode active material layer on the current collector, the positive electrode active material layer comprising a positive electrode active material,
wherein the positive electrode active material comprises
about 75 wt % to about 100 wt % of a first positive electrode active material in a form of single particles and comprising a lithium nickel-based composite oxide having a nickel content of greater than or equal to about 70 mol % relative to a total metal content of the lithium nickel-based composite oxide excluding lithium and oxygen, and
about 0 wt % to about 25 wt % of a second positive electrode active material in a form of secondary particles in each of which a plurality of primary particles are aggregated and comprising a lithium nickel-based composite oxide, and
in an X-ray diffraction analysis of the positive electrode, a ratio of a peak intensity of a (003) plane to a peak intensity of a (104) plane is greater than or equal to about 4.8.

2. The positive electrode of claim 1, wherein, in an X-ray diffraction analysis of the positive electrode, a peak full width at half maximum (FWHM) of the (003) plane is less than or equal to about 0.12.

3. The positive electrode of claim 1, wherein the positive electrode has a density of greater than or equal to about 3.4 g/cc.

4. The positive electrode of claim 1, wherein the positive electrode active material comprises about 90 wt % to about 100 wt % of the first positive electrode active material and about 0 wt % to about 10 wt % of the second positive electrode active material.

5. The positive electrode of claim 4, wherein, in an X-ray diffraction analysis of the positive electrode, a ratio of a peak intensity of the (003) plane to a peak intensity of the (104) plane is greater than or equal to about 6.5.

6. The positive electrode of claim 1, wherein the positive electrode active material comprises about 75 wt % to about 95 wt % of the first positive electrode active material about 5 wt % to about 25 wt % of the second positive electrode active material.

7. The positive electrode of claim 6, wherein, in an X-ray diffraction analysis of the positive electrode, a ratio of a peak intensity of the (003) plane to a peak intensity of the (104) plane is about 4.8 to about 6.5.

8. The positive electrode of claim 1, wherein the lithium nickel-based composite oxide of the first positive electrode active material is represented by Chemical Formula 1: 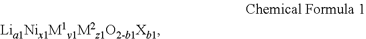
and
wherein, in Chemical Formula 1, 0.9≤a1≤1.8, 0.7≤x1≤1, 0≤y1≤0.3, 0≤z1≤0.3, 0.9≤x1+y1+z1≤1.1, 0≤b1≤0.1, M¹ and M² are each independently at least one element of Al, B, Ba, Ca, Ce, Co, Cr, Cu, Fe, Mg, Mn, Mo, Nb, Si, Sr, Ti, V, W, or Zr; and X is at least one element of F, P, or S.

9. The positive electrode of claim 1, wherein the first positive electrode active material comprises a cobalt-free lithium nickel-based composite oxide.

10. The positive electrode of claim 9, wherein the cobalt-free lithium nickel-based composite oxide is represented by Chemical Formula 2: 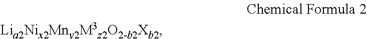
and
wherein, in Chemical Formula 2, 0.9≤a2≤1.8, 0.7≤x2<1, 0<y2≤0.3, 0≤z2≤0.3, 0.9≤x2+y2+z2≤1.1, 0≤b2≤0.1, M³ is at least one element of Al, B, Ba, Ca, Ce, Cr, Cu, Fe, Mg, Mo, Nb, Si, Sr, Ti, V, W, or Zr, and X is at least one element of S, F, or P.

11. The positive electrode of claim 1, wherein an average particle diameter (D50) of the single particles of the first positive electrode active material is about 1 μm to about 12 μm.

12. The positive electrode of claim 1, wherein the second positive electrode active material includes comprises a cobalt-free lithium nickel-based composite oxide having a nickel content of greater than or equal to about 70 mol % relative to a total metal content of the cobalt-free lithium nickel-based composite oxide excluding lithium and oxygen.

13. The positive electrode of claim 12, wherein the cobalt-free lithium nickel-based composite oxide of the second positive electrode active material is represented by Chemical Formula 2: 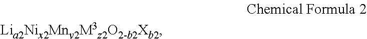
and
wherein, in Chemical Formula 2, 0.9≤a2≤1.8, 0.7≤x2<1, 0<y2≤0.3, 0≤z2≤0.3, 0.9≤x2+y2+z2≤1.1, 0≤b2≤0.1, M³ is at least one element of Al, B, Ba, Ca, Ce, Cr, Cu, Fe, Mg, Mo, Nb, Si, Sr, Ti, V, W, or Zr, and X is at least one element of F, P, or S.

14. The positive electrode of claim 1, wherein an average particle diameter (D50) of the secondary particles of the second positive electrode active material is about 5 μm to about 20 μm.

15. A rechargeable lithium battery comprising the positive electrode according to claim 1, a negative electrode, and an electrolyte.
